(19) United States
(12) Patent Application Publication
(10) Pub. No.: US 2026/0340730 A1
(43) Pub. Date: Oct. 29, 2026

(54) SYSTEM AND METHOD FOR MONITORING, DRIFT DETECTION, AND GOVERNANCE IN LARGE LANGUAGE MODEL-BASED FINANCIAL SYSTEMS

(71) Applicants: GOPICHAND TALLURI, Overland Park, KS (US); NAVYA VEGINATI, Overland Park, KS (US)

(72) Inventors: GOPICHAND TALLURI, Overland Park, KS (US); NAVYA VEGINATI, Overland Park, KS (US)

(21) Appl. No.: 19/697,827

(22) Filed: Jun. 4, 2026

(51) Int. Cl. G06Q 40/06; G06Q 30/018

(52) U.S. Cl. CPC G06Q 40/06; G06Q 30/018

(57) ABSTRACT

A method for monitoring, drift detection, and governance in one or more large language model (LLM)-based financial systems is disclosed. The method includes receiving, by at least one processor, a plurality of financial data inputs associated with one or more financial operations executed through at least one LLM-based financial system. The method includes generating one or more financial outputs associated with financial analysis, recommendation, prediction, compliance evaluation, transaction processing, customer interaction, or risk assessment. The method includes receiving operational data. The method includes identifying one or more variations associated with model performance, output consistency, regulatory compliance, financial accuracy, contextual alignment, or response reliability. The method includes detecting one or more model drift conditions. The method includes determining one or more governance actions. The method includes executing the determined one or more governance actions to regulate operation of the at least one LLM-based financial system.

### COPYRIGHT AND TRADEMARK NOTICE

This application includes material which is subject or may be subject to copyright and/or trademark protection. The copyright and trademark owner(s) have no objection to the facsimile reproduction by any of the patent disclosure, as it appears in the Patent and Trademark Office files or records, but otherwise reserves all copyright and trademark rights whatsoever.

### TECHNICAL FIELD

The present disclosure generally relates to artificial intelligence-based financial computing systems. More particularly, the present disclosure relates to systems and methods for monitoring, drift detection, adaptive governance, and operational control in large language model (LLM)-based financial systems operating in distributed computing environments.

### BACKGROUND OF THE INVENTION

Financial institutions are increasingly deploying large language models (LLMs) for executing financial operations including customer interaction processing, fraud analysis, investment recommendation generation, compliance evaluation, document interpretation, transaction analysis, and automated decision support. Such LLM-based financial systems are often integrated with cloud infrastructure, real-time transaction platforms, retrieval-augmented generation (RAG) frameworks, and external financial data sources to provide scalable intelligent services. However, operational behavior of LLMs may vary over time due to changes in contextual inputs, evolving financial regulations, modifications in external data sources, adversarial prompts, model retraining events, or shifting transaction patterns.

Conventional monitoring frameworks used in financial computing environments are generally designed for deterministic software systems and are unable to effectively monitor probabilistic inference behavior associated with the LLMs. Existing approaches often fail to capture contextual inference telemetry, semantic output variations, prompt-response inconsistencies, embedding-level behavioral deviations, or dynamically changing response characteristics generated during execution of LLM-based financial operations. As a result, unnoticed model drift conditions lead to inaccurate financial recommendations, inconsistent compliance outputs, hallucinated responses, elevated operational risks, or unauthorized data exposure.

Further, existing governance mechanisms in financial systems typically rely on static policy enforcement and manual audit procedures that operate independently from real-time model inference operations. Such approaches are unable to dynamically correlate operational telemetry with governance controls or automatically execute corrective actions responsive to detected model drift conditions. Additionally, conventional audit systems lack technical mechanisms for maintaining end-to-end traceability of prompts, inference states, contextual retrieval operations, model decisions, and governance execution events within distributed LLM environments.

Accordingly, there exists a need for improved technical solutions capable of continuously monitoring operational telemetry generated by LLM-based financial systems, detecting drift conditions in real time, dynamically executing governance controls, and maintaining verifiable auditability across distributed financial computing infrastructures.

### SUMMARY OF THE INVENTION

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a method for monitoring, drift detection, and governance in one or more large language model (LLM)-based financial systems is disclosed. The method includes receiving, by at least one processor, a plurality of financial data inputs associated with one or more financial operations executed through at least one LLM-based financial system. The method includes generating, by the at least one processor, one or more financial outputs associated with financial analysis, recommendation, prediction, compliance evaluation, transaction processing, customer interaction, or risk assessment. The method includes receiving, by the at least one processor, operational data associated with the generated one or more financial outputs. The method includes monitoring, by the at least one processor, the operational data and the generated one or more financial outputs to identify one or more variations associated with model performance, output consistency, regulatory compliance, financial accuracy, contextual alignment, or response reliability. The method includes detecting, by the at least one processor, one or more model drift conditions based on the identified one or more variations. The method includes determining, by the at least one processor, one or more governance actions responsive to the detected one or more model drift conditions. The method includes executing, by the at least one processor, the determined one or more governance actions to regulate operation of the at least one LLM-based financial system.

In accordance with another embodiment of the present disclosure, a system for monitoring, drift detection, and governance in one or more large language model (LLM)-based financial systems is disclosed. The system includes a memory and at least one processor is operatively coupled with the memory. The at least one processor is configured to receive a plurality of financial data inputs associated with one or more financial operations executed through at least one LLM-based financial system. The at least one processor is configured to generate one or more financial outputs associated with financial analysis, recommendation, prediction, compliance evaluation, transaction processing, customer interaction, or risk assessment. The at least one processor is configured to receive operational data associated with the generated one or more financial outputs. The at least one processor is configured to monitor the operational data and the generated one or more financial outputs to identify one or more variations associated with model performance, output consistency, regulatory compliance, financial accuracy, contextual alignment, or response reliability. The at least one processor is configured to detect one or more model drift conditions based on the identified one or more variations. The at least one processor is configured to determine one or more governance actions responsive to the detected one or more model drift conditions. The at least one processor is configured to execute the determined one or more governance actions to regulate operation of the at least one LLM-based financial system.

In accordance with another embodiment of the present disclosure, a non-transitory computer-readable medium storing instructions that, when executed, cause a processor to receive a plurality of financial data inputs associated with one or more financial operations executed through at least one LLM-based financial system. The at least one processor is configured to generate one or more financial outputs associated with financial analysis, recommendation, prediction, compliance evaluation, transaction processing, customer interaction, or risk assessment. The at least one processor is configured to receive operational data associated with the generated one or more financial outputs. The at least one processor is configured to monitor the operational data and the generated one or more financial outputs to identify one or more variations associated with model performance, output consistency, regulatory compliance, financial accuracy, contextual alignment, or response reliability. The at least one processor is configured to detect one or more model drift conditions based on the identified one or more variations. The at least one processor is configured to determine one or more governance actions responsive to the detected one or more model drift conditions. The at least one processor is configured to execute the determined one or more governance actions to regulate operation of the at least one LLM-based financial system.

One or more advantages of the prior art are overcome, and additional advantages are provided through the invention. Additional features are realized through the technique of the invention. Other embodiments and aspects of the disclosure are described in detail herein and are considered a part of the invention.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates an environment for monitoring, drift detection, and governance in one or more Large Language Model (LLM)-based financial systems, in accordance with one or more embodiments of the present disclosure;

FIG. 2A illustrates a block diagram depicting an exemplary architecture of an LLM-based financial system, in accordance with one or more embodiments of the present disclosure;

FIG. 2B illustrates a block diagram depicting modules associated with the LLM-based financial system, in accordance with one or more embodiments of the present disclosure; and

FIG. 3A-FIG. 3B illustrates a flowchart depicting a method for monitoring, drift detection, and governance in the one or more LLM-based financial systems, in accordance with one or more embodiments of the present disclosure.

Skilled artisans will appreciate the elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed. It shall be understood that different aspects of the invention can be appreciated individually, collectively, or in combination with each other.

The present disclosure provides systems and methods for monitoring, drift detection, and adaptive governance in Large Language Model (LLM)-based financial systems operating within distributed computing environments. The disclosed system enables continuous acquisition and processing of financial data inputs through one or more large language models configured to generate financial outputs associated with transaction analysis, compliance evaluation, customer interaction processing, fraud detection, investment recommendation generation, and risk assessment operations. The disclosed architecture further enables continuous collection of operational telemetry and inference metadata including contextual embeddings, token probability distributions, execution traces, confidence indicators, retrieval-context information, and response behavior characteristics associated with operation of the one or more large language models.

The LLMs may comprise machine-learning models configured to process structured data, semi-structured data, unstructured textual data, or combinations thereof associated with financial transaction requests. The LLMs may be integrated with the LLM-based financial system 102 to generate machine-readable outputs utilized during transaction processing.

The LLMs may be implemented using transformer-based neural network architectures trained on domain-specific datasets, transaction-related records, governance policies, security policies, audit records, compliance documents, customer interaction records, or combinations thereof. The LLMs operate as analytical components configured to receive transaction-related inputs and generate structured outputs for use by the modules 210 of the LLM-based financial system 102.

The present disclosure provides a real-time governance framework configured to identify operational variations and model drift conditions associated with LLM-based financial systems. The disclosed framework enables continuous monitoring of semantic behavior, contextual consistency, inference reliability, and compliance alignment through telemetry vector analysis, anomaly detection operations, and embedding-based divergence evaluation. Responsive to detection of one or more model drift conditions, the disclosed system dynamically executes governance actions including inference parameter modification, workload redistribution, model isolation, rollback execution, policy enforcement, human validation routing, and adaptive retraining operations. The disclosed architecture further enables generation of immutable audit records, inference traceability information, and explainability metadata to support secure governance, regulatory verification, and operational reliability within Artificial Intelligence (AI) driven financial computing infrastructures.

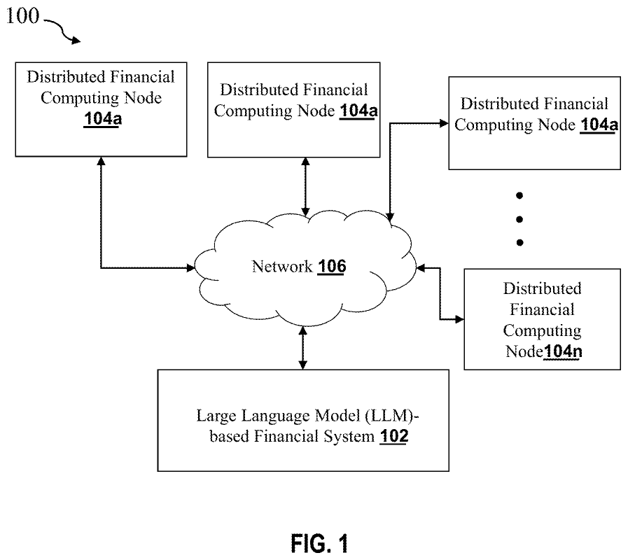

An environment and various implementations for environment and processes may be described with reference to FIG. 1 showing an architectural level schematic of a system in accordance with an implementation. Because FIG. 1 is an architectural diagram, certain details are intentionally omitted to improve the clarity of the description. The discussion of FIG. 1 will be organized as follows. First, the elements of the figure will be described, followed by their interconnections. Then, the use of the elements in the environment will be described in greater detail.

Referring now to the drawings, and more particularly to FIG. 1 through FIG. 3A-3B, where similar reference characters denote corresponding features consistently throughout the figures, there are shown preferred embodiments and these embodiments are described in the context of the following exemplary system and/or method.

FIG. 1 illustrates a block diagram depicting an environment 100 for monitoring, drift detection, and governance in one or more LLM-based financial systems, in accordance with one or more embodiments of the present disclosure.

As illustrated in FIG. 1, the environment 100 includes an LLM-based financial system 102, a plurality of distributed financial computing nodes 104a, 104b, 104c . . . 104n, and a network 106 configured to facilitate communication among components of the environment 100. The network 106 may include a public network, private network, cloud communication infrastructure, enterprise communication framework, wireless communication network, or combinations thereof.

In one embodiment, the LLM-based financial system 102 may include one or more large language models configured to process a plurality of financial data inputs and generate one or more financial outputs associated with one or more financial operations. The one or more financial outputs may include, but are not limited to, one or more compliance responses, one or more investment recommendations, one or more fraud analysis results, one or more transaction classifications, one or more customer support responses, one or more risk evaluation outputs, and the like.

The one or more financial operations may include customer interaction processing, financial recommendation generation, fraud analysis, compliance verification, investment analysis, portfolio management, transaction monitoring, document interpretation, risk assessment, or automated decision support operations. The LLM-based financial system 102 may further include one or more inference engines, orchestration engines, retrieval-augmented generation (RAG) engines, policy engines, governance engines, telemetry collection engines, or audit management engines.

In one embodiment, the plurality of distributed financial computing nodes 104a, 104b, 104c . . . 104n may correspond to cloud computing nodes, edge computing nodes, financial institution servers, transaction processing systems, regulatory databases, customer interaction servers, application servers, hybrid computing infrastructure components, and the like. The plurality of configured to exchange financial information with the LLM-based financial system 102. Each distributed financial computing node 104a, 104b, 104c . . . , or 104n may generate operational telemetry, contextual execution data, prompt-response data, inference metadata, and financial transaction data associated with execution of the one or more financial operations.

The network 106 may include one or more wired networks, wireless networks, virtual private networks, cloud communication networks, software-defined networks, or combinations thereof configured to facilitate secure transmission of the plurality of financial data inputs, operational data, governance policies, telemetry vectors, and audit information between the LLM-based financial system 102 and the plurality of distributed financial computing nodes 104a, 104b, 104c . . . 104n.

In one embodiment, the LLM-based financial system 102 may be configured to receive the plurality of financial data inputs from the plurality of distributed financial computing nodes 104a, 104b, 104c . . . 104n through the network 106. The plurality of financial data inputs may include, but are not limited to, structured financial records, transaction streams, conversational financial queries, regulatory information, customer interaction data, market data feeds, or contextual retrieval data. The LLM-based financial system 102 may process the plurality of financial data inputs through one or more large language models to generate one or more financial outputs.

In one embodiment, the LLM-based financial system 102 may capture operational data associated with generation of the one or more financial outputs. The operational data may include, but are not limited to, token probability distributions, prompt-response embeddings, contextual execution identifiers, inference latency metrics, Graphics Processing Unit (GPU) utilization metrics, model version information, prompt transformation metadata, retrieval context identifiers, response confidence values, semantic representations, and execution trace information.

The LLM-based financial system 102 may continuously monitor the operational data and the generated one or more financial outputs to identify one or more variations associated with model performance, contextual alignment, semantic consistency, response reliability, regulatory compliance, or financial accuracy. In one embodiment, the identified one or more variations may include embedding divergence conditions, contextual inconsistencies, anomalous inference behavior, hallucination indicators, abnormal response latency patterns, or unauthorized access behavior.

In one embodiment, the LLM-based financial system 102 may detect one or more model drift conditions based on the identified one or more variations. The one or more model drift conditions may correspond to semantic drift, compliance drift, adversarial prompt drift, retrieval drift, statistical drift, hallucination drift, contextual drift, or inference behavior drift. The one or more model drift conditions may be determined by comparing current telemetry vectors with historical telemetry vectors stored within one or more monitoring repositories.

Further, the LLM-based financial system 102 may determine one or more governance actions responsive to the detected one or more model drift conditions. The one or more governance actions may include generating alerts, dynamically modifying inference execution parameters, isolating one or more model instances, initiating rollback operations, restricting model access permissions, routing outputs for human validation, initiating retraining operations, or updating governance policies.

In one embodiment, the LLM-based financial system 102 may execute the determined one or more governance actions in real time to regulate operation of the one or more large language models. The LLM-based financial system 102 may further store monitoring information, detected drift information, governance action information, telemetry vectors, and audit information within one or more repositories to enable traceability, compliance verification, explainability analysis, and adaptive governance.

In one embodiment, the LLM-based financial system 102 may correspond to an intelligent financial computing platform configured to process the plurality of financial data inputs using the one or more large language models for performing financial analysis, compliance evaluation, fraud detection, conversational financial assistance, investment recommendation generation, transaction monitoring, and risk assessment operations. The LLM-based financial system 102 may include one or more AI inference engines, orchestration engines, telemetry processing engines, governance control engines, retrieval-augmented generation (RAG) frameworks, policy management engines, and audit management components configured to collectively manage execution of the one or more financial operations within distributed computing environments.

In one embodiment, the LLM-based financial system 102 may be configured to receive structured financial data, unstructured financial documents, customer interaction data, transaction streams, regulatory datasets, market feeds, contextual retrieval data, and external financial intelligence data from one or more distributed financial computing nodes. The LLM-based financial system 102 may process the received plurality of financial data inputs using one or more transformer-based large language models, domain-adapted language models, multimodal financial AI models, or retrieval-augmented language models to generate one or more financial outputs associated with the one or more financial operations.

Further, the LLM-based financial system 102 may continuously capture operational metadata associated with execution of the one or more large language models. The operational metadata may include token probability distributions, contextual embedding vectors, inference execution identifiers, prompt-response mappings, retrieval-context metadata, response confidence values, latency metrics, GPU utilization information, semantic representations, and model execution traces. Such operational metadata may be utilized for identifying the one or more variations, semantic inconsistencies, compliance deviations, hallucination behavior, adversarial prompt interactions, or contextual drift conditions associated with the generated one or more financial outputs.

In one embodiment, the LLM-based financial system 102 may further include a real-time telemetry monitoring pipeline configured to analyze machine-readable telemetry vectors generated during inference cycles. The telemetry monitoring pipeline may execute vector similarity computations, anomaly detection operations, statistical divergence analysis, contextual alignment analysis, and threshold evaluation operations to continuously monitor operational behavior of the one or more large language models.

The LLM-based financial system 102 may further include a drift detection framework configured to detect one or more model drift conditions associated with semantic drift, contextual drift, compliance drift, adversarial prompt drift, retrieval drift, hallucination drift, or inference reliability degradation. In one embodiment, the drift detection framework may compare real-time telemetry vectors with historical baseline embeddings and validated inference signatures stored within one or more monitoring repositories.

In one embodiment, the LLM-based financial system 102 may further include a governance execution framework configured to dynamically determine and execute governance actions responsive to the detected one or more model drift conditions. The governance actions may include modifying inference execution parameters, restricting model access permissions, isolating one or more model instances, initiating rollback operations, reallocating inference workloads, triggering retraining procedures, activating secondary validated models, routing outputs for human review, or updating governance policies.

Further, the LLM-based financial system 102 may maintain monitoring information, telemetry vectors, governance execution logs, audit records, inference trace graphs, prompt lineage information, explainability metadata, and drift signatures within one or more persistent repositories or immutable distributed ledgers to facilitate traceability, compliance verification, operational explainability, and adaptive governance associated with AI-driven financial operations.

In one exemplary implementation, the LLM-based financial system 102 may be deployed within cloud computing infrastructures, hybrid financial computing environments, distributed banking platforms, edge computing environments, or multi-region financial processing systems configured to support real-time AI-driven financial operations across geographically distributed computing nodes.

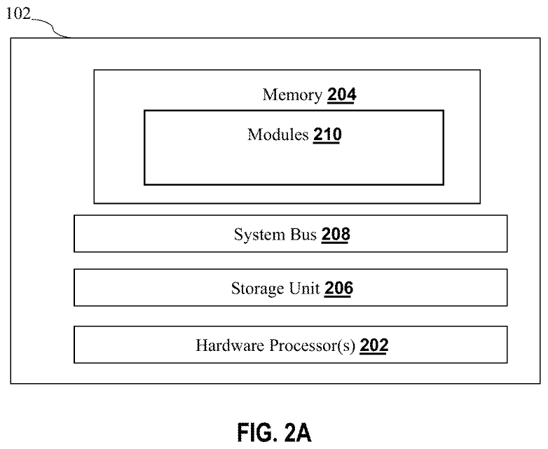

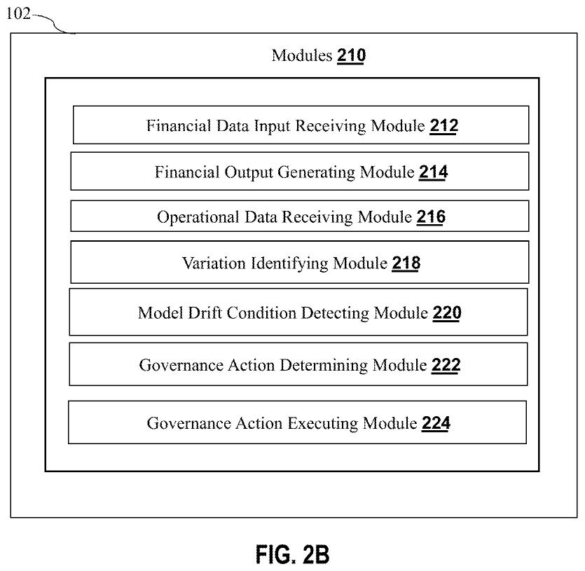

FIG. 2A illustrates a block diagram depicting an architecture of the LLM-based financial system 102, in accordance with one or more embodiments of the present disclosure. The LLM-based financial system 102 may include a processor 202, a memory 204, a storage unit 206, a system bus 208, and modules 210.

In one embodiment, the processor 202 may include one or more microprocessors, graphical processing units (GPUs), tensor processing units (TPUs), neural processing units (NPUs), digital signal processors, distributed processing cores, or combinations thereof configured to execute machine-readable instructions associated with monitoring, drift detection, telemetry processing, governance execution, and financial inference operations.

The memory 204 may include a volatile memory, a non-volatile memory, a cache memory, a dynamic random-access memory (DRAM), a static random-access memory (SRAM), or other machine-readable storage media configured to temporarily store operational data, telemetry vectors, financial data inputs, contextual embeddings, governance policies, and executable instructions.

The storage unit 206 may include one or more databases, distributed storage systems, object storage repositories, ledger repositories, or persistent storage devices configured to store monitoring information, audit records, governance execution logs, historical telemetry vectors, model configurations, baseline embeddings, inference trace graphs, and drift signatures.

The system bus 208 may provide communication pathways among the processor 202, the memory 204, the storage unit 206, the modules 210, and the network interface. In one embodiment, the system bus 208 may include high-speed communication buses configured to support real-time telemetry exchange and distributed inference operations.

The modules 210 may include machine-readable instructions executable by the processor 202 for performing operations associated with receiving the plurality of financial data inputs, generating the one or more financial outputs, capturing operational data, identifying variations, detecting the one or more model drift conditions, determining the governance actions, and executing the governance actions.

The network interface may include one or more communication interfaces configured to establish communication with the plurality of distributed financial computing nodes 104a, 104b, 104c . . . 104n through the network 106. The network interface may support secure communication protocols, encrypted financial data transmission, telemetry streaming, remote governance execution, and distributed model synchronization.

FIG. 2B illustrates a block diagram depicting the modules 210 of the LLM-based financial system 102, in accordance with one or more embodiments of the present disclosure.

In one embodiment, the modules 210 may include a financial data input receiving module 212 configured to receive the plurality of financial data inputs from the one or more distributed financial computing nodes 104a, 104b, 104c . . . 104n. The plurality of financial data inputs may include, but is not limited to, transaction records, conversational financial requests, compliance datasets, regulatory updates, contextual retrieval data, market feeds, customer interaction data, and the like.

In an example scenario, a user initiates a digital payment transaction using a mobile banking application executing on a client device. The mobile banking application generates a transaction request. The transaction request includes a transaction identifier, a source account identifier, a destination account identifier, transaction amount, a transaction timestamp, and a device identifier.

The financial data input receiving module 212 receives the transaction request through a communication interface and extracts the transaction-related data fields. The financial data input receiving module 212 validates the data structure, associates the transaction request with a session identifier, and stores the received data in a transaction processing queue for subsequent processing by downstream modules.

The modules 210 may further include a financial output generating module 214 configured to process the plurality of financial data inputs through the one or more large language models to generate the one or more financial outputs.

In an example scenario, following processing of a financial transaction request, the LLM-based financial system 102 determines a transaction decision state. The financial output generating module 214 generates a transaction authorization output. The transaction authorization output includes an authorization status indicator, transaction execution identifier, and transaction processing timestamp.

After completion of a funds transfer transaction, the financial output generating module 214 generates a structured output record. The structured output record includes the source account identifier, the destination account identifier, the transfer amount, the transaction completion status, and settlement information.

In one embodiment, the modules 210 may include an operational data receiving module 216 configured to receive the operational data associated with generation of the one or more financial outputs. The operational data may include token probability distributions, embedding representations, inference latency metrics, contextual execution identifiers, model execution traces, retrieval augmentation metadata, confidence values, GPU utilization metrics, or semantic response representations.

The modules 210 may further include a variation identifying module 218 configured to continuously monitor the operational data and the generated one or more financial outputs to identify one or more variations associated with model performance, semantic consistency, compliance accuracy, contextual alignment, or inference reliability. In one embodiment, the variation identifying module 218 may execute vector similarity computations, anomaly detection operations, statistical comparisons, threshold evaluations, or semantic divergence analyses.

The modules 210 may further include a model drift condition detecting module 220 configured to detect one or more model drift conditions based on the identified one or more variations. The model drift condition detecting module 220 may generate drift signatures corresponding to semantic drift, contextual drift, compliance drift, hallucination drift, adversarial prompt drift, or statistical drift conditions.

In one embodiment, the modules 210 may include a governance action determining module 222 configured to determine one or more governance actions responsive to the detected one or more model drift conditions. The one or more governance actions may include dynamic inference parameter modification, governance policy selection, rollback execution, alert generation, access restriction, retraining initiation, human validation routing, or model isolation operations.

The modules 210 may further include a governance action executing module 224 configured to execute the determined one or more governance actions to regulate operation of the LLM-based financial system 102. In one embodiment, the governance action executing module 224 may dynamically modify token generation thresholds, reallocate inference workloads to validated model instances, suspend unauthorized model operations, or update governance execution policies in real time.

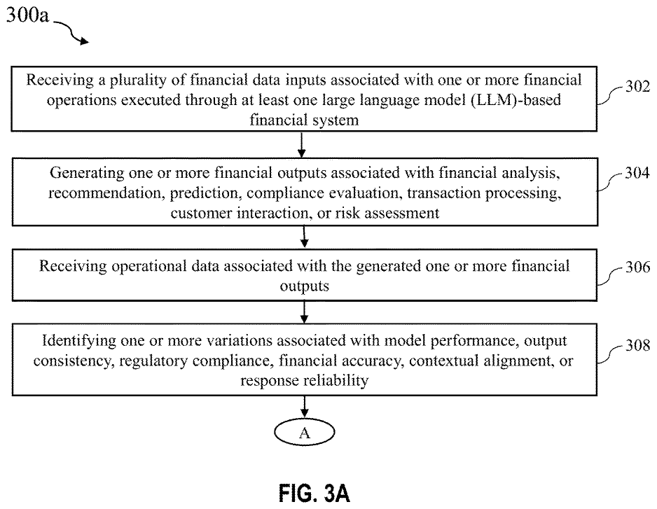

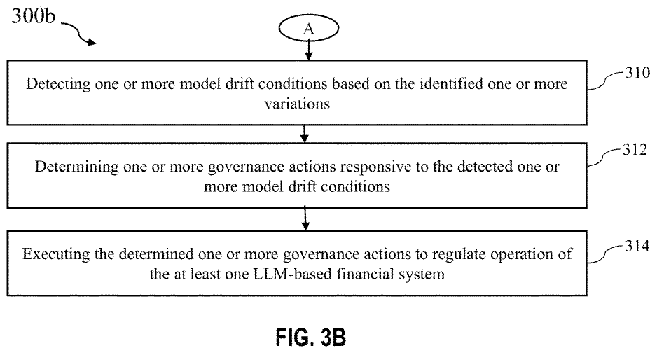

FIG. 3A illustrates a flowchart depicting a method 300a for monitoring, drift detection, and governance in one or more LLM-based financial systems, in accordance with one or more embodiments of the present disclosure.

At step 302, the method 300a may include receiving, by the financial data input receiving module 212, the plurality of financial data inputs associated with one or more financial operations executed through the LLM-based financial system 102.

At step 304, the method 300a may include processing, by the financial output generating module 214, the plurality of financial data inputs through the one or more large language models to generate the one or more financial outputs.

At step 306, the method 300a may include receiving, by the operational data receiving module 216, the operational data associated with generation of the one or more financial outputs.

At step 308, the method 300a may include continuously monitoring, by the variation identifying module 218, the operational data and the generated one or more financial outputs to identify the one or more variations associated with operational behavior of the LLM-based financial system 102.

Referring to FIG. 3B, at step 310, the method 300b may include detecting, by the model drift condition detecting module 220, the one or more model drift conditions based on the identified one or more variations.

At step 312, the method 300b may include determining, by the governance action determining module 222, the one or more governance actions responsive to the detected one or more model drift conditions.

At step 314, the method 300b may include executing, by the governance action executing module 224, the determined one or more governance actions to regulate operation of the LLM-based financial system 102.

The operational data may include model behavior information, response characteristics, execution parameters, contextual information, user interaction information, decision trace information, confidence indicators, data lineage information, retrieval-augmented generation (RAG) context identifiers, external data source identifiers, and prompt transformation data associated with the generated one or more financial outputs.

In an embodiment, for receiving the plurality of financial data inputs, the method 300a may include receiving, through one or more network interfaces, streaming financial transaction data, tokenized conversational data, and model inference telemetry generated by the one or more distributed financial computing nodes 104a, 104b, 104c . . . 104n.

The method 300a-300b may include storing, by the at least one processor 202, monitoring information, detected drift information, governance action information, and audit information in one or more repositories to enable traceability, compliance verification, and adaptive governance of the at least one LLM-based financial system.

The one or more model drift conditions correspond to deviations between historical operational characteristics and current operational characteristics of the at least one LLM-based financial system 102.

The one or more governance actions may include at least one of generating one or more alerts, initiating one or more validation workflows, applying one or more policy controls, restricting one or more model operations, modifying one or more access permissions, triggering one or more retraining procedures, updating one or more governance rules, or recording audit information.

In an embodiment, for detecting the one or more model drift conditions, the method 300a-300b may include detecting at least one of statistical drift, semantic drift, contextual drift, behavioral drift, regulatory drift, performance drift, confidence drift, or adversarial interaction drift.

In an embodiment, for determining the one or more governance actions, the method 300a-300b may include determining a governance severity level based on at least one of a magnitude of deviation, a financial impact value, a compliance impact value, a security impact value, or a confidence score associated with the detected one or more model drift conditions. The governance severity level may include a machine-readable classification value associated with the financial transaction request and used by the LLM-based financial system 102 to govern application of policy parameters, verification procedures, and mitigation actions during transaction processing.

The one or more governance actions may be executed in real time during generation of the one or more financial outputs.

The methods may be implemented in any suitable hardware, software, firmware, or combination thereof.

In one exemplary implementation, the LLM-based financial system 102 may be deployed within a cloud-based financial advisory platform configured to generate investment recommendations for retail banking customers. The LLM-based financial system 102 may operate across the one or more distributed financial computing nodes 104a-104n hosted in geographically distributed data centers. In one implementation, approximately 2.5 million customer advisory requests may be processed per day through a 70-billion-parameter large language model integrated with a retrieval-augmented generation (RAG) engine.

In one implementation, the financial data input receiving module 212 may receive approximately 50,000 financial advisory requests per minute through the network 106. The received financial data inputs may include customer portfolio information, market trend data, regulatory advisories, risk tolerance values, transaction histories, and contextual investment queries. The financial output generating module 214 may process the plurality of financial data inputs to generate investment recommendation outputs with an average inference latency of approximately 760 milliseconds per request.

The operational data receiving module 216 may receive the operational data including token probability distributions, inference confidence values, contextual embeddings, GPU utilization metrics, and retrieval-context identifiers. In one implementation, telemetry vectors having dimensions of 4,086 embedding parameters may be generated for each inference cycle and stored within a time-series monitoring repository.

During operation, the variation identifying module 218 may continuously compare real-time embedding representations against baseline embeddings generated during validated compliance operation states. In one implementation, cosine similarity scores below 0.82 may be identified as anomalous semantic divergence conditions. The model drift condition detecting module 220 may determine that recommendation outputs generated during a specific market volatility period exhibit compliance drift associated with recently updated financial regulatory rules.

In response, the governance action determining module 222 may automatically classify the detected drift condition as a high-severity governance event having a compliance risk score of 82 on a 100-point governance severity scale. The governance action executing module 224 may dynamically reduce token generation limits from 2,044 tokens to 512 tokens, activate a secondary validated compliance model, and route approximately 16% of generated financial recommendations for human compliance review.

In one implementation, the governance action executing module 224 may further isolate two inference nodes exhibiting abnormal hallucination drift conditions and redistribute workloads to validated model instances operating within a secondary cloud cluster. The disclosed implementation may reduce generation of non-compliant investment recommendations by approximately 87% within 4 minutes after drift detection.

In another exemplary implementation, the LLM-based financial system 102 may be integrated with a digital banking fraud detection infrastructure configured to analyze conversational transaction requests and detect anomalous banking behavior. The distributed financial computing nodes 104a-104n may include mobile banking servers, payment gateways, fraud analytics engines, and transaction authorization systems interconnected through the network 106.

In one implementation, the financial data input receiving module 212 may receive approximately 120,000 transaction-related conversational requests per hour. The financial output generating module 214 may process transaction narratives, customer authentication data, merchant information, and geolocation metadata to generate fraud risk assessment outputs.

The operational data receiving module 216 may capture telemetry vectors including prompt embeddings, response confidence values, inference execution identifiers, retrieval-source identifiers, and token probability gradients. In one implementation, the telemetry repository may store approximately 15 terabytes of operational data per month.

During execution, the variation identifying module 218 may be configured to identify abnormal prompt-response divergence associated with coordinated adversarial prompt injection attempts targeting transaction authorization workflows. In one implementation, prompt embedding distances exceeding a threshold value of 1.75 standard deviations from baseline transaction embeddings may trigger anomaly alerts.

The model drift condition detecting module 220 may be configured to classify the detected anomaly as adversarial prompt drift associated with synthetic fraud-generation attempts. The governance action determining module 222 may dynamically select a fraud governance policy from a governance repository containing 250 executable governance policies.

The governance action executing module 224 may automatically suspend high-risk conversational transaction approval operations, initiate multi-factor verification workflows, and reduce transaction authorization confidence thresholds from 94% to 78% for affected sessions. Further, the governance action executing module 224 may redirect transaction processing requests to a validated backup inference model operating in a segregated secure computing environment.

In one implementation, the disclosed system may reduce false-negative fraud authorization events by approximately 63% while maintaining transaction processing latency below 1.2 seconds during peak operational conditions.

In another exemplary implementation, the LLM-based financial system 102 may be deployed across a hybrid multi-cloud financial infrastructure supporting banking operations in multiple geographic regions. The distributed financial computing nodes 104a-104n may include regional compliance servers, customer interaction engines, distributed inference clusters, and cloud-native governance repositories.

In one implementation, the LLM-based financial system 102 may process approximately 8 million customer interaction sessions per day across North America, Europe, and Asia-Pacific regions. Each regional inference cluster may execute localized large language models trained using region-specific compliance requirements and financial regulations.

The operational data receiving module 216 may continuously collect telemetry vectors including contextual retrieval identifiers, regional policy mappings, inference trace graphs, token attribution mappings, and model execution metrics. In one implementation, telemetry streams may be generated at a rate of approximately 2.8 gigabytes per minute across the distributed infrastructure.

During operation, the variation identifying module 218 may detect increasing contextual drift associated with changes in regional anti-money laundering regulations introduced within one geographic region. The model drift condition detecting module 220 may identify that response consistency values for compliance-related outputs decreased from 96.4% to 81.7% over a six-hour operational interval.

In response, the governance action determining module 222 may initiate adaptive governance execution workflows. The governance action executing module 224 may dynamically update governance policies, activate region-specific compliance filters, and initiate incremental retraining operations using newly received regulatory datasets containing approximately 12 million updated compliance records.

Further, the governance action executing module 224 may perform workload redistribution across regional cloud inference clusters to maintain uninterrupted financial operations while retraining affected model instances. In one implementation, the disclosed system may restore compliance response consistency to approximately 95.8% within 3.2 hours following detection of the contextual drift condition.

Additionally, audit information, governance execution logs, telemetry vectors, and drift signatures may be cryptographically hashed and stored within a distributed immutable audit ledger replicated across 14 geographically distributed storage nodes. Such implementation may enable verifiable compliance auditing and tamper-resistant governance traceability across the distributed financial infrastructure.

Thus, various embodiments of the present disclosure provide a technical solution for continuously monitoring operational telemetry generated by one or more large language model (LLM)-based financial systems in real time. The present disclosure receives machine-level inference metadata including embedding representations, token probability distributions, contextual execution identifiers, and inference latency metrics, the disclosed system improves visibility into operational behavior of distributed AI-driven financial computing environments.

The present disclosure improves technical detection of model drift conditions within LLM-based financial systems. The disclosed system utilizes telemetry vector analysis, semantic divergence evaluation, anomaly detection operations, and contextual embedding comparisons to identify semantic drift, compliance drift, hallucination drift, adversarial prompt drift, and contextual inference deviations that may not be detectable using conventional deterministic monitoring systems.

The present disclosure improves reliability and operational stability of financial computing systems by dynamically executing governance actions responsive to detected model drift conditions. The disclosed governance framework enables automated modification of inference execution parameters, model isolation operations, rollback execution, workload reallocation, and adaptive policy enforcement, thereby reducing propagation of inaccurate or non-compliant financial outputs.

The present disclosure improves real-time operational control of distributed LLM infrastructures by integrating telemetry monitoring pipelines with governance execution engines. Such integration enables low-latency identification of abnormal inference behavior and corresponding automated corrective actions without requiring manual intervention, thereby improving responsiveness of AI-driven financial platforms.

The present disclosure improves explainability and traceability associated with AI-generated financial outputs by maintaining inference trace graphs, prompt-response mappings, contextual dependency information, governance execution logs, and audit metadata. Such technical mechanisms facilitate verifiable reconstruction of inference operations and governance events across distributed computing environments.

The present disclosure improves security and integrity of financial AI systems by enabling detection of adversarial prompt interactions, unauthorized inference behavior, abnormal telemetry patterns, and retrieval-context inconsistencies. The disclosed system further enables automated restriction of compromised model instances and controlled execution of validated governance policies.

The present disclosure improves scalability of monitoring and governance operations within cloud-based and distributed financial computing environments. The disclosed architecture supports coordinated telemetry collection and distributed drift analysis across multiple financial computing nodes, thereby enabling efficient governance of large-scale LLM deployments.

The present disclosure improves computational efficiency associated with drift detection operations through generation of machine-readable telemetry vectors and adaptive threshold evaluation mechanisms. The disclosed architecture reduces unnecessary manual audits and minimizes computational overhead associated with static compliance validation frameworks.

The present disclosure improves integrity and immutability of audit operations by storing monitoring information, governance execution information, and drift signatures within tamper-resistant storage repositories and distributed audit ledgers. Such implementation enables verifiable compliance validation and secure preservation of governance records.

The present disclosure improves adaptive learning capabilities of governance systems by continuously retraining drift detection models using previously generated telemetry vectors, governance execution outcomes, and detected drift signatures. This enables progressive enhancement of drift detection accuracy and governance responsiveness across evolving financial environments.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via the system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. A method for monitoring, drift detection, and governance in one or more large language model (LLM)-based financial systems, the method comprising:
receiving, at least one processor, a plurality of financial data inputs associated with one or more financial operations executed through at least one LLM-based financial system from one or more distributed financial computing nodes;
generating, by the at least one processor, one or more financial outputs associated with financial analysis, recommendation, prediction, compliance evaluation, transaction processing, customer interaction, or risk assessment;
receiving, by the at least one processor, operational data associated with the generated one or more financial outputs;
monitoring, by the at least one processor, the operational data and the generated one or more financial outputs to identify one or more variations associated with model performance, output consistency, regulatory compliance, financial accuracy, contextual alignment, or response reliability;
detecting, by the at least one processor, one or more model drift conditions based on the identified one or more variations;
determining, by the at least one processor, one or more governance actions responsive to the detected one or more model drift conditions; and
executing, by the at least one processor, the determined one or more governance actions to regulate operation of the at least one LLM-based financial system.

2. The method of claim 1, wherein the operational data comprises model behavior information, response characteristics, execution parameters, contextual information, user interaction information, decision trace information, confidence indicators, data lineage information, retrieval-augmented generation (RAG) context identifiers, external data source identifiers, and prompt transformation data associated with the generated one or more financial outputs.

3. The method of claim 1, wherein receiving the plurality of financial data inputs comprises:
receiving, through one or more network interfaces, streaming financial transaction data, tokenized conversational data, and model inference telemetry generated by the one or more distributed financial computing nodes.

4. The method of claim 1, further comprising:
storing, by the at least one processor, monitoring information, detected drift information, governance action information, and audit information in one or more repositories to enable traceability, compliance verification, and adaptive governance of the at least one LLM-based financial system.

5. The method of claim 1, wherein the one or more model drift conditions correspond to deviations between historical operational characteristics and current operational characteristics of the at least one LLM-based financial system.

6. The method of claim 1, wherein the one or more governance actions comprise at least one of generating one or more alerts, initiating one or more validation workflows, applying one or more policy controls, restricting one or more model operations, modifying one or more access permissions, triggering one or more retraining procedures, updating one or more governance rules, or recording audit information.

7. The method of claim 1, wherein detecting the one or more model drift conditions comprises:
detecting at least one of statistical drift, semantic drift, contextual drift, behavioral drift, regulatory drift, performance drift, confidence drift, or adversarial interaction drift.

8. The method of claim 1, wherein determining the one or more governance actions comprises:
determining a governance severity level based on at least one of a magnitude of deviation, a financial impact value, a compliance impact value, a security impact value, or a confidence score associated with the detected one or more model drift conditions.

9. The method of claim 1, wherein the one or more governance actions are executed in real time during generation of the one or more financial outputs.

10. A system for monitoring, drift detection, and governance in one or more large language model (LLM)-based financial systems, the system comprising:
a memory;
at least one processor is operatively coupled with the memory, wherein the at least one processor is configured to:
receive a plurality of financial data inputs associated with one or more financial operations executed through at least one LLM-based financial system;
generate one or more financial outputs associated with financial analysis, recommendation, prediction, compliance evaluation, transaction processing, customer interaction, or risk assessment;
receive operational data associated with the generated one or more financial outputs;
monitor the operational data and the generated one or more financial outputs to identify one or more variations associated with model performance, output consistency, regulatory compliance, financial accuracy, contextual alignment, or response reliability;
detect one or more model drift conditions based on the identified one or more variations;
determine one or more governance actions responsive to the detected one or more model drift conditions; and
execute the determined one or more governance actions to regulate operation of the at least one LLM-based financial system.

11. The system of claim 10, wherein the operational data comprises model behavior information, response characteristics, execution parameters, contextual information, user interaction information, decision trace information, confidence indicators, data lineage information, retrieval-augmented generation (RAG) context identifiers, external data source identifiers, and prompt transformation data associated with the generated one or more financial outputs.

12. The system of claim 10, wherein to receive the plurality of financial data inputs, the at least one processor is configured to:
receive, through one or more network interfaces, streaming financial transaction data, tokenized conversational data, and model inference telemetry generated by one or more distributed financial computing nodes.

13. The system of claim 10, wherein the at least one processor is configured to:
store monitoring information, detected drift information, governance action information, and audit information in one or more repositories to enable traceability, compliance verification, and adaptive governance of the at least one LLM-based financial system.

14. The system of claim 10, wherein the one or more model drift conditions correspond to deviations between historical operational characteristics and current operational characteristics of the at least one LLM-based financial system.

15. The system of claim 10, wherein the one or more governance actions comprise at least one of generating one or more alerts, initiating one or more validation workflows, applying one or more policy controls, restricting one or more model operations, modifying one or more access permissions, triggering one or more retraining procedures, updating one or more governance rules, or recording audit information.

16. The system of claim 10, wherein to detect the one or more model drift conditions, the at least one processor is configured to:
detect at least one of statistical drift, semantic drift, contextual drift, behavioral drift, regulatory drift, performance drift, confidence drift, or adversarial interaction drift.

17. The system of claim 10, wherein to determine the one or more governance actions, the at least one processor is configured to:
determine a governance severity level based on at least one of a magnitude of deviation, a financial impact value, a compliance impact value, a security impact value, or a confidence score associated with the detected one or more model drift conditions.

18. The system of claim 10, wherein the one or more governance actions are executed in real time during generation of the one or more financial outputs.

19. The system of claim 10, wherein the at least one LLM-based financial system and the at least one processor is configured to:
retrain one or more drift detection models using previously generated one or more telemetry vectors, one or more detected drift signatures, and one or more governance execution outcomes to improve subsequent real-time drift detection accuracy.

20. A non-transitory computer-readable medium storing instructions that, when executed, cause a processor to:
receive a plurality of financial data inputs associated with one or more financial operations executed through at least one LLM-based financial system;
generate one or more financial outputs associated with financial analysis, recommendation, prediction, compliance evaluation, transaction processing, customer interaction, or risk assessment;
receive operational data associated with the generated one or more financial outputs;
monitor the operational data and the generated one or more financial outputs to identify one or more variations associated with model performance, output consistency, regulatory compliance, financial accuracy, contextual alignment, or response reliability;
detect one or more model drift conditions based on the identified one or more variations;
determine one or more governance actions responsive to the detected one or more model drift conditions; and
execute the determined one or more governance actions to regulate operation of the at least one LLM-based financial system.
